(19) United States
(12) Patent Application Publication
(10) Pub. No.: US 2026/0211367 A1
(43) Pub. Date: Jul. 23, 2026

(54) IMAGE FORMING APPARATUS

(71) Applicant: CANON KABUSHIKI KAISHA, Tokyo (JP)

(72) Inventors: TAISUKE HYODO, Shizuoka (JP); TOMOOKU KOYAMA, Shizuoka (JP); HIROHARU TSUJI, Shizuoka (JP); SHINYA KAWAKAMI, Shizuoka (JP)

(21) Appl. No.: 19/453,644

(22) Filed: Jan. 20, 2026

(30) Foreign Application Priority Data
Jan. 21, 2025 (JP) 2025-008417

(51) Int. Cl. G03G 21/16

(52) U.S. Cl. CPC G03G 21/1633; G03G 21/1647; G03G 2221/163; G03G 2221/1639; G03G 2221/1684; G03G 2221/169

(57) ABSTRACT

An image forming apparatus includes a main assembly, a door, a moving unit and an urging member. The door is positioned in a closed state in which an inside of the main assembly is closed and an open state in which the inside is exposed. The moving unit is provided in the inside of the main assembly, capable of moving to an outside of the main assembly, and capable of moving from a fist position where the moving unit is mounted on the inside to a second position outside the main assembly. The urging member urges the moving unit so as to move the moving unit from the first position to the second position. The urging member expands and contracts in interrelation with an opening/closing operation of the door so that an urging force in the open state becomes larger than the urging force in the closed state.

### BACKGROUND

### Field of the Technology

The present invention relates to an image forming apparatus which forms an image on a sheet.

### Description of the Related Art

In image forming apparatuses such as printers, copy machines and multifunction machines, there is an image forming apparatus in which a unit inside the apparatus is movably configured. By the unit inside the apparatus being moved, it becomes easier to perform jam clearance, consumable replacement, etc. For example, in Japanese Patent Application Laid-Open No. 2012-047806, a configuration in which by a fixing device, which fixes an image formed on a recording medium, being movable toward outside the image forming apparatus, it becomes possible to perform the jam clearance, the maintenance operation, etc., is disclosed.

However, with the prior art, upon moving the fixing device toward outside the image forming apparatus, it is necessary to lift the fixing device against gravitational force, resulting in poor operability. To improve the operability, upon using a configuration, in which the movement of the fixing device is assisted by utilizing urging force of an urging member, before the movement of the fixing device, i.e., in a state in which an image formation is performed, it becomes a state in which a large amount of the urging force is accumulated in the urging member. Therefore, a large amount of load is always applied to a member which receives the urging force, so that there is a risk of deformation and/or damage of the member.

### SUMMARY

The present invention is conceived under such a background, and a purpose of the present invention is to provide, in a configuration in which a moving unit is movably provided in an image forming apparatus, an assisting mechanism for a moving unit which can reduce effect due to load from an urging member.

In order to solve the aforementioned problem, the present invention includes the following configurations.

According to an aspect of the present invention, there is provided an image forming apparatus comprising: a main assembly; an openable/closable door between a closed state in which an inside of the main assembly is closed and an open state in which the inside is exposed; a moving unit provided in the inside of the main assembly and capable of moving to an outside of the main assembly, the moving unit being capable of moving from a first position where the moving unit is mounted on the inside of the main assembly to a second position outside the main assembly and different from the first position when the door is in the open state; and an urging member configured to urge the moving unit so as to move the moving unit from the first position to the second position, wherein the urging member expands and contracts in interrelation with an opening/closing operation of the door so that an urging force when the door is in the open state becomes larger than the urging force when the door is in the closed state.

Further features of the present invention will become apparent from the following description of exemplary embodiments with reference to the attached drawings.

### BRIEF DESCRIPTION OF THE DRAWINGS

FIG. 1 is a perspective view of an image forming apparatus in Embodiments 1 through 4.

FIG. 2 is a cross-sectional outline view of the image forming apparatus in the Embodiment 1.

FIG. 3 is a perspective view of the image forming apparatus in the Embodiment 1.

FIG. 4, part (a) and part (b), includes perspective views of a moving mechanism in the Embodiment 1.

FIG. 5, part (a), part (b) and part (c), includes operation views of the moving mechanism in the Embodiment 1.

FIG. 6 is an operation view of a moving mechanism in the Embodiment 2.

FIG. 7, part (a) and part (b), includes perspective views of an image forming apparatus in the Embodiment 3.

FIG. 8, part (a) and part (b), includes operation views of a tray unit in the Embodiment 3.

FIG. 9 is a perspective view of a moving mechanism in the Embodiment 4.

FIG. 10, part (a), part (b) and part (c), includes operation views of the moving mechanism in the Embodiment 4.

FIG. 11, part (a) and part (b), includes detailed views of the moving mechanism in the Embodiment 4.

### DESCRIPTION OF THE EMBODIMENTS

Hereinafter, exemplary Embodiments of the present invention will be described with reference to the drawings.

### Embodiment 1

### [Overall Configuration]

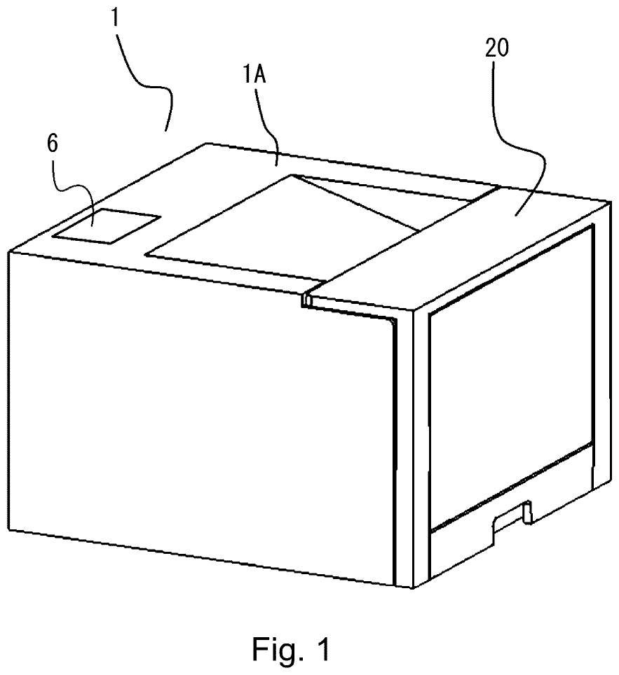

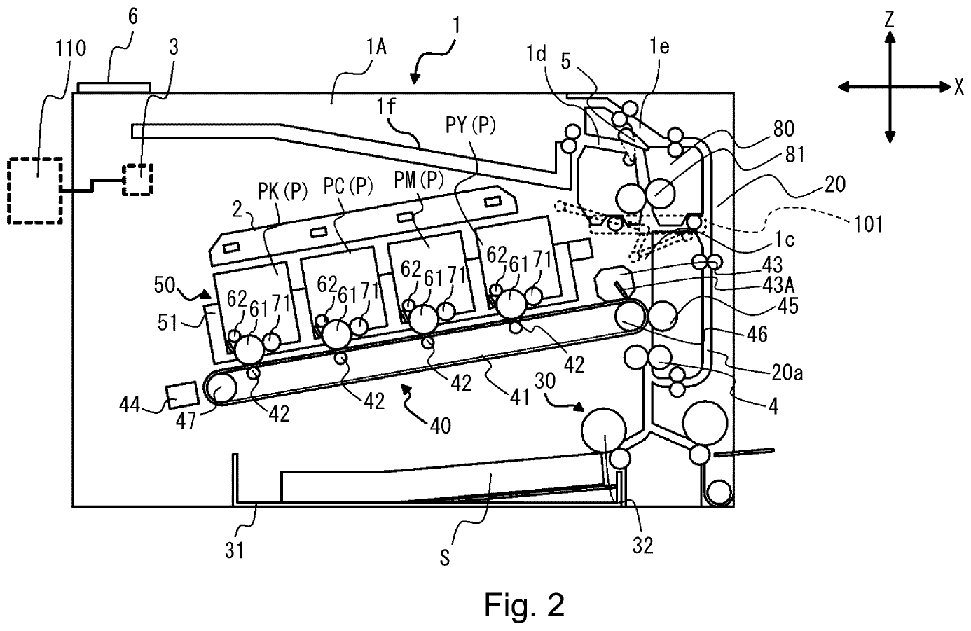

A printer 1 as an image forming apparatus will be described using FIG. 1 and FIG. 2. FIG. 1 is a perspective view illustrating an overall configuration of the printer 1 in an Embodiment 1. FIG. 2 is a cross-sectional outline view of the printer 1, in particular, a view of the printer 1 during image formation. Here, a vertical direction is defined as a Z direction, and in a horizontal plane perpendicular to the Z direction, a moving direction of a tray unit 50, which will be described below, is defined as an X direction, and a direction perpendicular to the X direction in the horizontal direction is defined as a Y direction. According to this, when a user views the printer 1 from a front thereof, the X direction becomes a front and back direction, and the Y direction becomes a left and right direction.

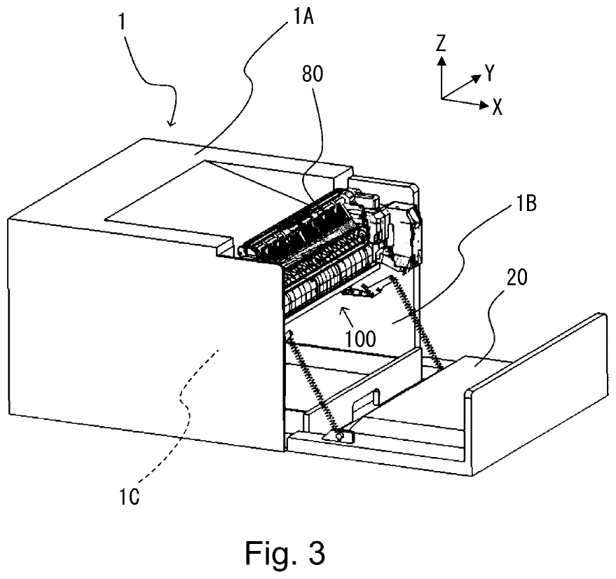

The printer 1 is a color laser beam printer of an electrophotographic type, which forms an image on a sheet S as a recording material. In FIG. 1, a door 20 is openable/closable, and is configured to be capable of rotating with respect to a main assembly 1A (housing). The main assembly 1A includes a frame 1B and a frame 1C (see FIG. 3). As shown in FIG. 2, the printer 1 includes the main assembly 1A, a scanner 2 (exposure device), a control portion 3, a sheet feeding portion 30, a transfer unit 40 (transfer device), the tray unit 50, a fixing device 80, a mounting base 101 and an operating panel 6.

The main assembly 1A accommodates the scanner 2, the control portion 3, the sheet feeding portion 30, the transfer unit 40, the tray unit 50, the fixing device 80 and the mounting base 101. The sheet feeding portion 30 includes a stacking tray 31 which stacks the sheet S and a supplying roller 32. The stacking tray 31 is capable of being drawn out in a direction toward the door 20 to replenish the sheet S.

The tray unit 50 includes a tray 51 and cartridges PY, PM, PC and PK. The cartridges PY, PM, PC and PK are detachably mounted (equipped) to the tray 51. Each of the cartridges PY, PM, PC and PK is mountable to and demountable from the tray 51 independently from the others. The cartridges PY, PM, PC and PK (toner cartridges) accommodate toner (developer) of yellow (Y), magenta (M), cyan (C) and black (K), respectively. In addition, configurations of the cartridges PY, PM, PC and PK are the same, except that the colors of the accommodated toner are different. Therefore, the configuration and operation of one of the cartridges PY, PM, PC or PK will be described, and descriptions of the others will be omitted. In addition, when it is not necessary to distinguish the cartridges PY, PM, PC and PK, the cartridges PY, PM, PC and PK are simply referred to as a cartridge P. In other words, it can be said that the tray unit 50 includes a plurality of the cartridges P and the tray 51, to which the plurality of the cartridges P are detachably mounted.

In the Embodiment 1, the tray unit 50 includes a plurality of photosensitive drums 61 (image bearing members), a plurality of charging rollers 62 (charging members), and a plurality of developing rollers 71 (developer carrying members). Specifically, the tray unit 50 includes four photosensitive drums 61, four charging rollers 62, and four developing rollers 71. A rotational axis direction of the photosensitive drum 61, a rotational axis direction of the developing roller 71, and a rotational axis direction of the charging roller 62 are parallel to each other.

A portion which forms an image of black (K) is referred to as a black station (first station), and of the first station, the photosensitive drum 61 as a first photosensitive drum, the developing roller 71 as a first developing roller, and the charging roller 62 as a first charging roller. A portion which forms an image of cyan (C) is referred to as a cyan station (second station), and of the second station, the photosensitive drum 61 as a second photosensitive drum, the developing roller 71 as a second developing roller, and the charging roller 62 as a second charging roller. A portion which forms an image of magenta (M) is referred to as a magenta station (third station), and of the third station, the photosensitive drum 61 as a third photosensitive drum, the developing roller 71 as a third developing roller, and the charging roller 62 as a third charging roller. A portion which forms an image of yellow (Y) is referred to as a yellow station (fourth station), and of the fourth station, the photosensitive drum 61 as a fourth photosensitive drum, the developing roller 71 as a fourth developing roller, and the charging roller 62 as a fourth charging roller.

The cartridge PK is mounted on the black station, the cartridge PC on the cyan station, the cartridge PM on the magenta station, and the cartridge PY on the yellow station, respectively. In the Embodiment 1, the cartridge PK is referred to as a first cartridge, the cartridge PC as a second cartridge, the cartridge PM as a third cartridge, and the cartridge PY as a fourth cartridge. Incidentally, the numbers such as the first, the second, the third and the fourth are used for convenience for the description. In addition, it is sufficient that the photosensitive drum 61, the charging roller 62, and the developing roller 71 are provided to either of the cartridge P or the tray 51. In the Embodiment 1, the cartridge P includes the photosensitive drum 61, the charging roller 62 and the developing roller 71.

The transfer unit 40 includes a belt 41, a primary transfer roller 42, a cleaning portion 43, a driving roller 46, which drives the belt 41, and a tension roller 47 (driven roller). In the printer 1 in the Embodiment 1, an optical sensor 44, which detects a toner image which has been transferred to the belt 41, is disposed. In the Embodiment 1, the belt 41 is disposed below the photosensitive drum 61, and is contactable to the photosensitive drum 61 so that a primary transfer portion is formed between the belt 41 and the photosensitive drum 61. In addition, the printer 1 includes a secondary transfer roller 45, which is in contact with the belt 41 so that a secondary transfer portion is formed. The secondary transfer portion is formed between the belt 41 and the secondary transfer roller 45. A rotational axis direction of the primary transfer roller 42, a rotational axis direction of the driving roller 46, a rotational axis direction of the tension roller 47, and a rotational axis direction of the secondary transfer roller 45 are parallel to each other. In a conveyance direction of the sheet S, to an upstream of the secondary transfer portion, a registration roller pair 4 is disposed.

The fixing device 80 includes a fixing portion 81 and a flapper 5. The fixing portion 81 includes a heating roller, inside which a heat generating member is provided, and a pressing roller, which forms a fixing nip by being opposite and pressed against the heating roller. When an image forming operation to the sheet S is performed, the fixing device 80 is accommodated inside the main assembly 1A, and at a use position determined by the main assembly 1A. Here, the use position, in other words, a position at which the fixing device 80 is accommodated (mounted) inside the main assembly 1A and can perform the image forming operation (fixing operation) is defined as a first position. The mounting base 101 has a shape extending in a longitudinal direction of the fixing device 80 (direction perpendicular to a plane of the paper in FIG. 2), is positioned below the fixing device 80, and is fixed to the fixing device 80 with a slight gap therebetween during image forming operation. The mounting base 101 will be described below.

The flapper 5 is capable of moving between a discharging position (solid line), at which the flapper 5 guides the sheet S which has passed through the fixing device 80 toward a discharging path 1d, and a reversing position (broken line), at which the flapper 5 guides the sheet S toward a reversing path 1e. In addition, in the main assembly 1A, a conveyance path 1c (first path, first conveyance path), through which the sheet S heading toward the fixing device 80 passes, is formed. Furthermore, in the door 20, a double-side conveyance path 20a (second path, second conveyance path), through which the sheet S which has passed through the fixing device 80 passes, is formed. The door 20 covers the conveyance path 1c in a closed state in which an inside of the main assembly 1A is closed. By the door 20 becoming an open state in which the inside of the main assembly 1A is exposed (released), the conveyance path 1c and the double-side conveyance path 20a are exposed.

The operating panel 6 has a function as a display means which displays information related to status of the printer 1, and a function as an inputting means to which various kinds of information is input from a user. The control portion 3 displays information on the operating panel 6 according to the status of the printer 1. In addition, the control portion 3 can also control the printer 1 according to the information input from the user. So far is the description for the overall configuration of the printer 1 in the Embodiment 1.

### [Image Forming Operation]

Next, the image forming operation of the printer 1 will be described using FIG. 2. The control portion 3 in the printer 1 starts, according to an image signal received from an external host device 110, the image forming operation to the sheet S. The external host device 110 is, for example, a personal computer, an image reader, a facsimile device, etc.

First, formation of the toner image will be described. A charging voltage is applied to the charging roller 62, and the photosensitive drum 61 is rotated. The photosensitive drum 61 is irradiated with a laser, which corresponds to the image information, from the scanner 2, and a surface of the photosensitive drum 61, which has been charged by the charging roller 62, is exposed. By this, on the surface of the photosensitive drum 61, an electrostatic latent image corresponding to the image information is formed.

The developing roller 71 carries the toner. A developing voltage is applied to the developing roller 71, the electrostatic latent image formed on the photosensitive drum 61 is developed by the toner supplied from the developing roller 71, and the toner image is formed on the surface of the photosensitive drum 61. In the Embodiment 1, the developing roller 71 develops the electrostatic latent image in a state of being in contact with the photosensitive drum 61, however, the developing roller 71 may develop the electrostatic latent image in a state in which a gap is present between the developing roller 71 and the photosensitive drum 61. When a full-color image is formed, on each of the photosensitive drums 61, the toner image of each color is formed.

Incidentally, in the Embodiment 1, the developing roller 71 is capable of moving between a contact position, at which the developing roller 71 is in contact with the photosensitive drum 61, and a separated position, at which the developing roller 71 is separated from the photosensitive drum 61. Specifically, by a switching device (not shown) provided to the main assembly 1A, it is switched to a state in which the developing roller 71 is at the contact position and to a state in which the developing roller 71 is at the separated position. By this, in a state in which the image forming operation is not performed, it becomes possible to separate the developing roller 71 from the photosensitive drum 61.

In addition, the printer 1 can perform a monochrome printing in a state in which the developing roller 71 corresponding to the cartridge PK and the photosensitive drum 61 are in contact with each other, and the developing rollers 71 corresponding to each of the cartridges PY, PM and PC are separated from the photosensitive drum 61. In addition, the printer 1 can perform a full-color printing in a state in which the developing rollers 71, which correspond to each of the cartridges PY, PM, PC and PK, and the corresponding photosensitive drums 61 are in contact with each other, and the photosensitive drums 61 are in contact with the belt 41.

Next, transfer of the toner image to the sheet S will be described. The toner images which have been formed on each photosensitive drum 61 are transferred, in the primary transfer portion, onto the belt 41 by the primary transfer rollers 42 (primary transfer), and are conveyed toward the secondary transfer portion, which is formed by the belt 41 and the secondary transfer roller 45. In the sheet feeding portion 30, from the sheets S stacked on the stacking tray 31, a single sheet S is separated and fed by the supplying roller 32 at a predetermined timing, and is conveyed through the conveyance path 1c toward the secondary transfer portion and the fixing device 80.

In the secondary transfer portion, the toner image is transferred from the belt 41 to the sheet S (secondary transfer). The toner, which has not been transferred to the sheet S, is removed from the belt 41 by a cleaning blade 43A (cleaning member) provided inside the cleaning portion 43. The sheet S, to which the toner image has been transferred in the secondary transfer portion, is conveyed toward the fixing device 80. In the fixing device 80, the sheet S is heated and pressed in the fixing portion 81, and the toner image is fixed to the sheet S. The sheet S, to which the toner image has been fixed, is conveyed toward the flapper 5 as a path switching portion.

In a case in which a single-side printing, in which the image is formed on one side of the sheet S, is performed, the sheet S is guided by the flapper 5 to the discharging path 1d, and discharged to a discharge tray 1f formed at an upper portion of the main assembly 1A. On the other hand, in a case in which a double-side printing, in which the images are printed on the one side (front side) and a back side of the sheet S, the sheet S is guided by the flapper 5 to the reversing path 1e. After the sheet S is guided to the reversing path 1e, the conveyance direction of the sheet S is reversed, and in addition, by the flapper 5 being switched, the sheet S is conveyed, through the double-side conveyance path 20a formed in the door 20, again toward the secondary transfer portion. In the secondary transfer portion, after the toner image is transferred to the back side of the sheet S, the sheet S passes through the fixing device 80, is guided by the flapper 5 to the discharging path 1d, and is discharged to the discharge tray 1f of the main assembly 1A. So far is the description for the image forming operation of the printer 1 in the Embodiment 1.

### [Configuration and Operation of a Moving Mechanism]

Upon replacing the cartridge P, it is necessary to draw out the tray unit 50 in the direction toward the door 20. Upon drawing out the tray unit 50, since the fixing device 80 is disposed in a moving locus of the tray unit 50, by the fixing device 80 being moved above the main assembly, it becomes possible to draw out the tray unit 50. Hereinafter, a moving mechanism 100, which moves the fixing device 80 as a moving unit, which is provided inside the main assembly and capable of moving, will be described.

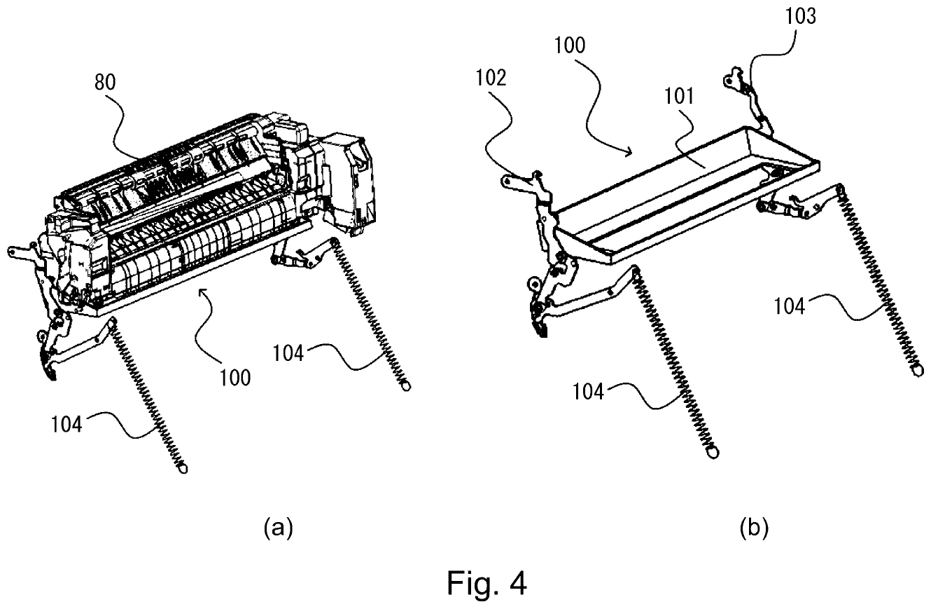

FIG. 3 is a perspective view of the printer 1 in a state in which the door 20 is opened, part (a) of FIG. 4 is a perspective view of a moving mechanism 100 and the fixing device 80, and part (b) of FIG. 4 is a perspective view of the moving mechanism 100. As shown in FIG. 3, in the state in which the door 20 is opened, the fixing device 80 is exposed. As shown in part (a) of FIG. 4, below the fixing device 80, the moving mechanism 100 is disposed. As shown in part (b) of FIG. 4, the moving mechanism 100 is constituted by the mounting base 101, a link mechanism 102, a link mechanism 103 and a spring 104. The link mechanisms 102 and 103 connect the spring 104 and the door 20.

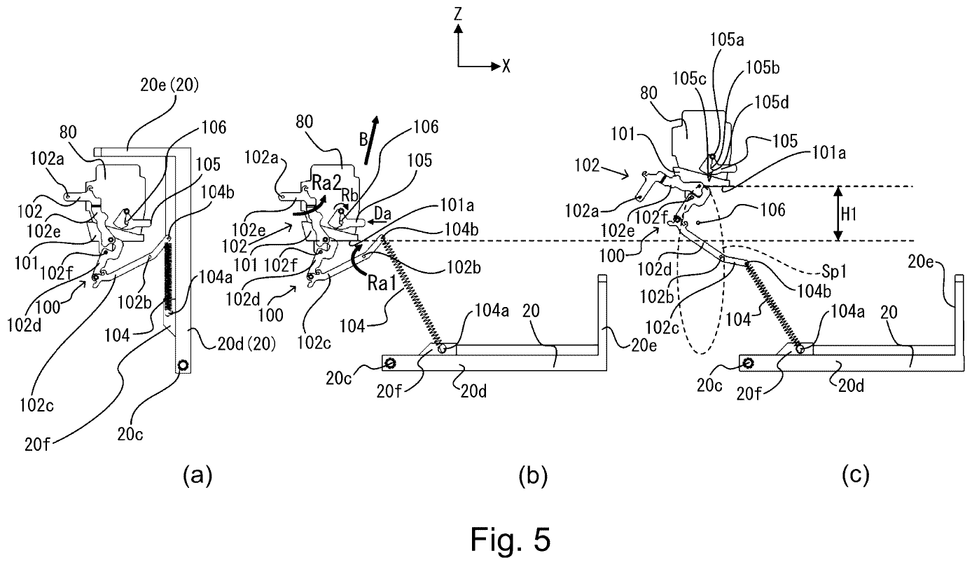

FIG. 5, part (a), part (b) and part (c), shows the configuration and operation of the moving mechanism 100. The mounting base 101 is connected to the link mechanisms 102 and 103 (not shown in part (a), part (b) and part (c) of FIG. 5), and the link mechanism 102 and the link mechanism 103 are connected to the door 20 by the springs 104, respectively. The spring 104 functions as an urging member, which expands and contracts in response to opening/closing operation of the door 20 and urges the moving unit. In addition, the spring 104 urges the fixing device 80 as the moving unit from the first position toward a second position. Here, the second position refers to a position at which the fixing device 80 is moved by an action of the moving mechanism 100 and stopped. The spring 104 is in interrelation with the opening/closing operation of the door 20 so that urging force when the door 20 is in the open state becomes larger than the urging force when the door 20 is in the closed state.

The link mechanism 102 is rotatable about a rotational center 102a and a rotational center 102b provided to the frame 1C of the main assembly 1A. Similarly, the link mechanism 103 is also rotatable about two rotational centers provided to the frame 1B of the main assembly 1A. A lock lever 105 is provided to the fixing device 80, and by being engaged with a lock pin 106 provided to the main assembly 1A, the fixing device 80 is restricted so as not to be moved. The lock lever 105 and the lock pin 106 function as a restricting member which is switched between a holding state of holding the fixing device 80 as the moving unit in the first position, and a releasing state of allowing the fixing device 80 to move from the first position. When the door 20 becomes the open state and the lock lever 105 and the lock pin 106 are in the releasing state, the fixing device 80 is moved toward the second position by the urging force of the spring 104.

It will be described in more detail. The door 20 has a surface 20d and a surface 20e, and as shown in part (a) of FIG. 5, etc., has a cross section of an L shape. The surface 20d is perpendicular to the X direction in the closed state in which the door 20 is closed, and perpendicular to the Z direction in the open state in which the door 20 is opened. The surface 20e is a surface which is bent from one edge of the surface 20d and is continuous to the surface 20d, and is perpendicular to the Z direction in the closed state in which the door 20 is closed, and is perpendicular to the X direction in the open state in which the door 20 is opened. The other edge of the surface 20d is attached to the main assembly 1A rotatably about a rotational shaft 20c. In other words, as the door 20 is viewed from the front thereof, the door 20 is capable of rotating about a lower side of the door 20 in the Z direction (vertical direction) as the rotational shaft 20c, and becomes the closed state or the open state by a rotational operation thereof. To the surface 20d of the door 20 on the inside of the main assembly 1A side, a connecting portion 20f which connects one end portion 104a of the spring 104 is provided, and the one end portion 104a of the spring 104 is connected to the connecting portion 20f.

The link mechanism 102 includes an arm 102c, an arm 102d and an arm 102e. In the arm 102c, the other end portion 104b of the spring 104 is connected to one end portion thereof, and one end portion of the arm 102d is connected to the other end portion thereof. At a connecting portion between the arm 102c and the arm 102d, the arm 102c and the arm 102d are capable of rotating relative to each other. The arm 102c is attached to the frame 1C (see FIG. 3) of the main assembly 1A rotatably about a rotational center 102b, and is capable of rotating about the rotational center 102b.

Of the arm 102d, one end portion is connected to the arm 102c, and the other end portion is connected to one end portion of the arm 102e. At a connecting portion between the arm 102d and the arm 102e, the arm 102d and the arm 102e are capable of rotating relative to each other. The arm 102d is connected to the mounting base 101 at a connecting portion 102f, and is capable of rotating about the connecting portion 102f. Of the arm 102e, one end portion is connected to the arm 102d, the other end portion is attached to the frame 1C of the main assembly 1A rotatably about a rotational center 102a, and is capable of rotating about the rotational center 102a.

In this manner, the link mechanism 102 is attached to the main assembly 1A at the rotational centers 102a and 102b, and the connecting portion 102f of the arm 102d is attached to the mounting base 101. One end portion 104a of the spring 104 is fixed to the door 20.

In the fixing device 80, the lock lever 105 is provided on a side surface thereof on a side opposite to the frame 1C, and can be engaged with the lock pin 106 fixed to the frame 1C. When the lock lever 105 is engaged with the lock pin 106, the fixing device 80 becomes the state of being fixed to the main assembly 1A. When the lock lever 105 is not engaged with the lock pin 106, the fixing device 80 becomes a state of not being fixed to the main assembly 1A, and becomes a state capable of moving.

As shown in part (c) of FIG. 5, the lock lever 105 includes a rotational shaft 105a, an engaging portion 105b, a tapered portion 105c and a corner portion 105d. In addition, the lock lever 105 is urged in an opposite direction to an arrow Rb direction, which will be described below, by an elastic member (not shown). Part (a) and part (b) of FIG. 5 illustrates the state in which the engaging portion 105b of the lock lever 105 is engaged with the lock pin 106. In this state, for example, when a user pushes the lock lever 105 in an arrow Da direction, the lock lever 105 is rotated about the rotational shaft 105a in the arrow Rb direction (see part (b) of FIG. 5), and the engagement between the lock lever 105 and the lock pin 106 is released.

Incidentally, when the fixing device 80 descends, the lock lever 105 and the lock pin 106 are engaged with each other naturally (automatically). As the lock lever 105 descends, the tapered portion 105c of the lock lever 105 is in contact with the lock pin 106, and the lock lever 105 is rotated about the rotational shaft 105a in the arrow Rb direction. When the lock pin 106 rides over the corner portion 105d along with the descends of the lock lever 105, the lock lever 105 is rotated about the rotational shaft 105a in the opposite direction to the arrow Rb direction, and the lock pin 106 is engaged with the engaging portion 105b. As a result, the fixing device 80 is fixed again to the main assembly 1A, and held in the first position.

Since the link mechanism 103 has the same configuration as the link mechanism 102, description thereof will be omitted. Incidentally, two rotational centers of the link mechanism 103 are provided to the frame 1B (see FIG. 3), and a lock pin 106, with which a lock lever 105 on the link mechanism 103 side is engaged, is also provided to the frame 1B. In addition, the lock lever on the link mechanism 103 side is provided to a surface side opposite to the frame 1B of the fixing device 80.

In the state in which the door 20 is closed shown in part (a) of FIG. 5, the spring 104 is in a state of slightly being expanded from a natural length thereof, so that elastic force generated in the spring 104 is extremely small. When the door 20 is opened from the state of part (a) of FIG. 5, the door 20 is rotated about the rotational shaft 20c, and by the spring 104 being pulled by the door 20, the elastic force of the spring 104 is increased (part (b) of FIG. 5). As the elastic force of the spring 104 is increased, the spring 104 generates force which causes the link mechanism 102 and the link mechanism 103 to be rotated. The fixing device 80 and the moving mechanism 100 are urged in a B direction shown in part (b) of FIG. 5.

Specifically, the spring 104 generates the force which causes the rotational center 102b of the arm 102c of the link mechanism 102 to be rotated in an arrow Ra1 direction. Furthermore, the spring 104 generates the force which causes the rotational center 102a of the arm 102e of the link mechanism 102 to be rotated in an arrow Ra2 direction. Incidentally, the same applies to the link mechanism 103. Here, the rotational direction in the arrow Ra2 direction (counterclockwise direction in part (b) of FIG. 5) is opposite to the rotational direction in the arrow Ra1 direction (clockwise direction in part (b) of FIG. 5), and by this, it becomes possible to generate force which urges the fixing device 80 and the moving mechanism 100 in the B direction.

However, since the lock lever 105 is engaged with the lock pin 106, the fixing device 80 is in the state of being fixed to the main assembly 1A, and is restricted from being moved even upon receiving the urging force in the B direction.

From the state of part (b) of FIG. 5, by performing the operation which causes the lock lever 105 to be released, the fixing device 80 and the moving mechanism 100 are moved in the direction B shown in part (b) of FIG. 5 by the elastic force of the spring 104. As a result, a lower surface 101a of the mounting base 101 is risen above by a height H1 from the state of part (b) of FIG. 5, and a space Sp1 is generated below the fixing device 80. Part (c) of FIG. 5 illustrates a state after the fixing device 80 is moved, and it becomes possible to draw out the tray unit 50 in this state. Incidentally, the link mechanism 102 and the link mechanism 103 may be urged by a plurality of springs, respectively, and any of the springs may be in interrelation with the door 20.

By configuring as described above, it becomes possible to obtain effects as following. That is, in the state in which the door 20 (opening/closing door) is closed, since the elastic force of the spring 104 (urging member), which causes the moving mechanism 100 and the fixing device 80 as the moving unit to be moved, is extremely small, it becomes possible to reduce force lord applied to peripheral components such as the moving mechanism 100 and the fixing device 80. In addition, upon opening the door 20, it becomes possible to prevent the door 20 from being opened forcefully due to the action of the elastic force of the spring 104.

### [Modified Example]

So far, the Embodiment 1 has been described, however, shapes, relative arrangements, etc. of the constituent components described in the Embodiment 1 should be modified as appropriately according to a configuration of an apparatus, to which the present invention is applied, and/or various types of conditions, and are not intended to limit the scope of the present invention. In the Embodiment 1, it is configured that the elastic force (urging force) of the spring 104 (urging member) becomes smaller in the state in which the door 20 (opening/closing door) is closed, however, it may be configured so as the elastic force of the spring 104 not to occur in the state in which the door 20 is closed. In addition, in the Embodiment 1, the elastic force of the spring 104 is changed by directly connecting the door 20 and the spring 104, however, the door 20 and the spring 104 may be indirectly connected via a separate component. In addition, in the Embodiment 1, the unit which is to be exposed by opening the door 20 is configured to be capable of moving (the moving unit), however, a unit which is exposed before the door 20 is opened may be configured to be capable of moving (the moving unit).

As described above, according to the Embodiment 1, in the configuration provided with the moving unit, which is movably provided to the image forming apparatus, it becomes possible to provide an assisting mechanism for the moving unit which can reduce effect due to load from the urging member.

### Embodiment 2

[Configuration and operation of a moving mechanism]

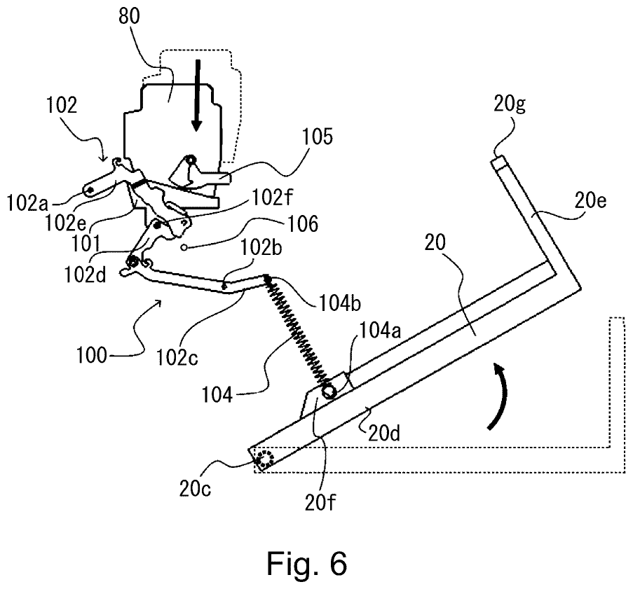

An Embodiment 2 will be described using part (a) of FIG. 5 through part (c) of FIG. 5 and FIG. 6. FIG. 6 is a view illustrating operation of a moving mechanism 100 in the Embodiment 2. Since a configuration and operation of the moving mechanism 100 shown in part (a) of FIG. 5 through part (c) of FIG. 5 are the same as in the Embodiment 1, description thereof will be omitted.

In a state shown in part (c) of FIG. 5, in which a fixing device 80 has been moved (a state of being at a second position), a fixing device 80 and the moving mechanism 100 are held so as not to fall by elastic force of a spring 104. The second position is located above a first position in the Z direction (vertical direction), and the urging force of the spring 104 is greater than gravitational force acting on the fixing device 80, so that the fixing device 80 is held at the second position by the urging force of the spring 104. It can be said that the spring 104 is a holding means for the fixing device 80. In other words, the moving mechanism 100 is set so that relationship of force that “a weight of the fixing device 80 <holding force by the spring” is satisfied between the weight of the fixing device 80 and the holding force of the spring 104.

As a door 20 gets to be closed from the state shown in part (c) of FIG. 5, the elastic force of the spring 104 is gradually decreased, and as shown in FIG. 6, the fixing device 80 comes to be lowered due to the gravitational force. In other words, when it becomes a state in which the fixing device 80 can no longer be held by the holding force of the spring 104, the fixing device 80 begins to descend. Incidentally, in FIG. 6, the state of the door 20 in part (c) of FIG. 5 is shown with a dotted line.

The elastic force of the spring 104 is set such that, in a process of closing the door 20, before the door 20 contacts the fixing device 80, the fixing device 80 sufficiently descends. Here, the contact between the door 20 and the fixing device 80 refers to, for example, a contact between a leading end portion 20g of a surface 20e of the door 20 (see FIG. 6) and the fixing device 80, a contact between the surface 20e and the fixing device 80, etc. In the Embodiment 2, the elastic force of the spring 104 is set such that, at a timing before the door 20 contacts the fixing device 80, it becomes no longer possible for the holding force of the spring 104 to hold the fixing device 80 and the fixing device 80 begins to descend. Therefore, in the process of closing the door 20, the door 20 and the fixing device 80 do not interfere with each other. In the process of closing the door 20, a lock lever 105 of the descending fixing device 80 is engaged again with a lock pin 106. By this, the fixing device 80 is fixed to a main assembly 1A.

By configuring as described above, it becomes possible to obtain effects as following. That is, in the state in which the door 20 (opening/closing door) is closed, the urging force of the spring 104 (urging member), which causes the moving mechanism 100 and the fixing device 80 (moving unit) to be moved, is extremely small, it becomes possible to reduce the force lord applied to the peripheral components such as the moving mechanism 100 and the fixing device 80. In addition, upon opening the door 20, by the action of the elastic force of the spring 104, it becomes possible to prevent the door 20 from being opened forcefully due to the gravitational force. Furthermore, in interrelation with the operation closing the door 20, by causing the fixing device 80 after the movement (at the second position) to be moved to the position at which the fixing device 80 is mounted on the main assembly 1A (first position) (hereinafter, referred to as a mounted position), it becomes not necessary for a user to get the fixing device 80 back to the first position, so that it becomes possible to improve usability. In addition, it becomes possible to prevent the fixing device 80 and/or the door 20 from being damaged by closing the door 20 in a state in which the fixing device 80 is not got back to the mounted position.

As described above, according to the Embodiment 2, in the configuration provided with the moving unit, which is movably provided to the image forming apparatus, it becomes possible to provide an assisting mechanism for the moving unit which can reduce effect due to load from the urging member.

### Embodiment 3

In an Embodiment 3, drawing out of a tray unit 50 will be described. In the Embodiment 3, the tray unit 50 corresponds to a moving unit. In addition, a position, at which the tray unit 50 is mounted on a main assembly 1A, corresponds to a first position. A position, at which the tray unit 50 is drawn out from the main assembly 1A, is moved and stops, corresponds to a second position. Incidentally, in the Embodiment 3, it will be described as a configuration in which a fixing device 80 is moved above and retracts.

### [Configuration and Operation of a Moving Mechanism]

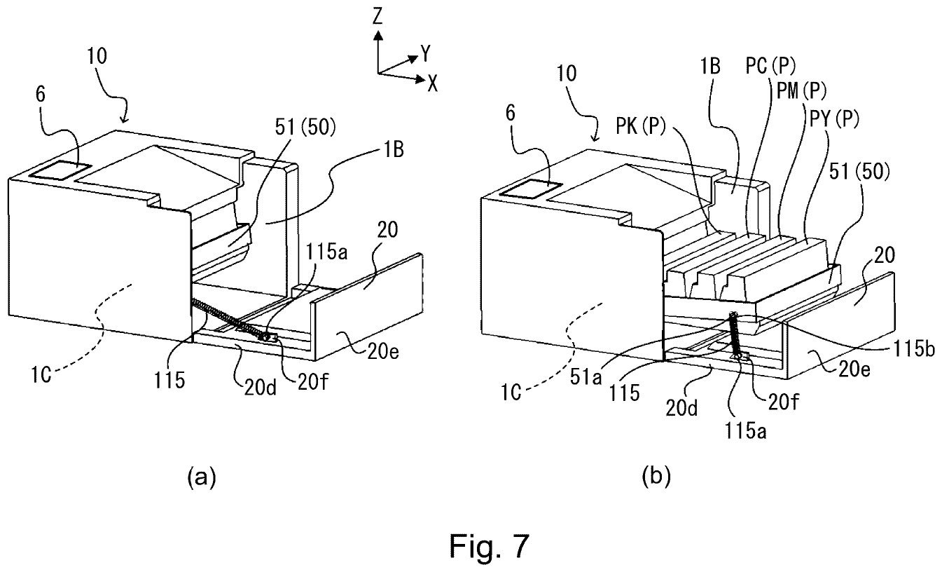

The Embodiment 3 will be described using part (a) of FIG. 7 and part (b) of FIG. 7. Part (a) of FIG. 7 and part (b) of FIG. 7 are perspective views of a printer 10 as an image forming apparatus in the Embodiment 3. To portions having the same configurations as in the Embodiment 1, the same reference numerals will be attached, and descriptions thereof will be omitted. Part (a) of FIG. 7 shows a state in which the door 20 is opened, and by opening the door 20, it becomes accessible to the tray unit 50. Part (b) of FIG. 7 shows a state in which the tray unit 50 is drawn out, and in this state, the cartridge P becomes replaceable. Upon drawing out the tray unit 50, the tray unit 50 is moved obliquely upward for a certain distance, and then moved in the horizontal direction (X direction).

The door 20 includes a connecting portion 20f as a first connecting portion, and a tray 51 of the tray unit 50 includes a connecting portion 51a as a second connecting portion. In a spring 115, one end portion 115a is connected to the connecting portion 20f of the door 20, and the other end portion 115b is connected to the connecting portion 51a of the tray 51. The spring 115 functions as an urging member, which expands and contracts in response to an opening/closing operation of the door 20 and urges the moving unit. In addition, the spring 115 urges the tray unit 50 as the moving unit from the first position toward the second position. The spring 115 is in interrelation with the opening/closing operation of the door 20 so that urging force when the door 20 is in the open state becomes larger than the urging force when the door 20 is in the closed state.

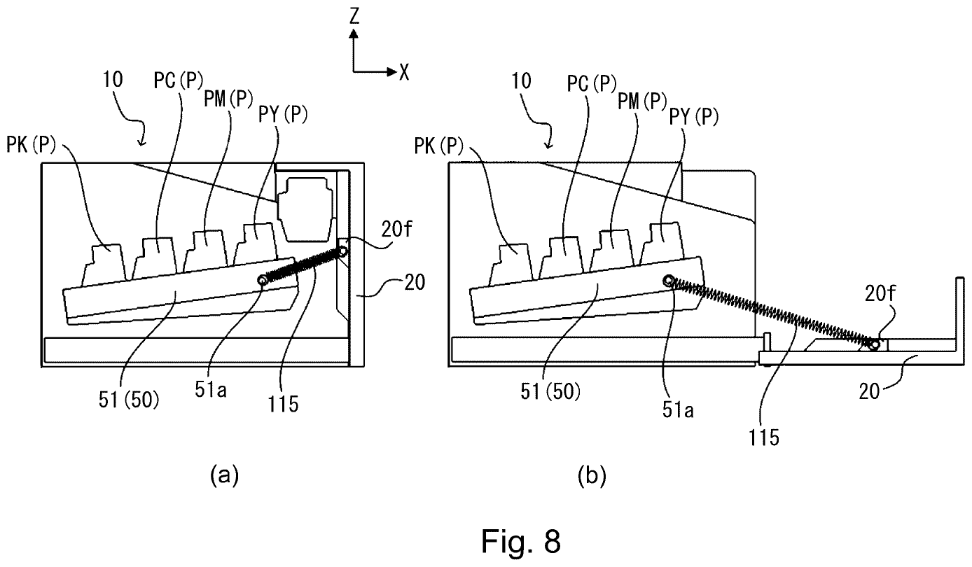

Part (a) of FIG. 8 and part (b) of FIG. 8 are cross-sectional outline views of the printer 10, and part (a) of FIG. 8 shows a state in which the door 20 is closed, and part (b) of FIG. 8 shows a state in which the door 20 is opened. As shown in part (a) of FIG. 8 and part (b) of FIG. 8, the tray unit 50 and the door 20 are connected by the spring 115. In the state of part (a) of FIG. 8, the spring 115 is slightly expanded from a natural length thereof, and elastic force generated in the spring 115 is extremely small. By opening the door 20 from this state, the spring 115 is expanded as shown in part (b) of FIG. 8, and the elastic force thereof is increased. The increased elastic force of the spring 115 is set lower than load which causes the tray unit 50 to be moved (force which causes the tray unit 50 to be moved against frictional force and the gravitational force), so that the tray unit 50 is not moved solely by the urging force of the spring 115. Therefore, even when the door 20 fully becomes the open state as shown in part (b) of FIG. 8, the tray unit 50 maintains a state of being mounted inside the main assembly 1A. However, upon a user drawing out the tray unit 50 from the inside of the main assembly 1A toward an outside, the elastic force of the spring 115 assists the drawing out operation, so that it becomes possible for the user to draw out the tray unit 50 with less force compared to a case in which the elastic force of the spring 115 is absent.

In addition, upon inserting the tray unit 50, the spring 115 is expanded by performing an inserting operation pushing the tray unit 50 into the inside of the main assembly 1A. As a result, the urging force of the spring 115 acts in an opposite direction to an inserting direction of the tray unit 50, so that momentum upon inserting the tray unit 50 into the inside of the main assembly 1A is reduced. Incidentally, as described above, the elastic force of the spring 115 is set lower than the load which causes the tray unit 50 to be moved. Therefore, in a process in which the user is inserting the tray unit 50 into the inside of the main assembly 1A, it does not occur that the tray unit 50 goes back in the opposite direction to the inserting direction (drawing out direction) due to the urging force of the spring 115. In addition, since the tray unit 50 is mounted on the main assembly 1A with being inclined so that a downstream side thereof (a back side as viewed from a user) is lower than an upstream side thereof (a near side as viewed from the user) in the inserting direction, the going back of the tray unit 50 upon the insertion is prevented.

Positional relationship between the connecting portion 51a of the tray 51 and the connecting portion 20f of the door 20 will be described. In the state in which the tray unit 50 is in the second position, it is sufficient to arrange so that, in the direction in which the tray unit 50 is drawn out (X direction), the connecting portion 51a is closer to the main assembly 1A than the connecting portion 20f (part (b) of FIG. 7). This is because, when this relationship is reversed, i.e., in a case in which the connecting portion 20f is closer in the X direction to the main assembly 1A than the connecting portion 51a, the urging force of the spring 115 acts so as to cause the tray unit 50 to be back to the first position.

By configuring as described above, it becomes possible to obtain effects as following. That is, in the state in which the door 20 (opening/closing door) is closed, since the elastic force acting on the door 20 and the tray unit 50 as the moving unit is extremely small, it becomes possible to reduce the load applied to the components. In addition, upon opening the door 20, by the elastic force of the spring 115, it becomes possible to prevent the door 20 from being opened forcefully. In addition, since the elastic force of the spring 115 is used as assisting force upon moving the tray unit 50, it becomes possible to set the elastic force of the spring 115 over a wide range according to the intended assisting force to act. Furthermore, even when the tray unit 50 is forcefully inserted into the main assembly 1A, the elastic force of the spring 115 contributes to prevent toner scattering and damage of the components.

Incidentally, in a single image forming apparatus, the configuration for urging the tray unit 50 in the Embodiment 3 and the configurations for urging the fixing device 80 described in the Embodiments 1 and 2 can be used together. In this case, it is sufficient to arrange so as the urging means (the spring 104 and the spring 115) not to interfere with each other.

As described above, according to the Embodiment 3, in the configuration provided with the moving unit, which is movably provided to the image forming apparatus, it becomes possible to provide an assisting mechanism for the moving unit which can reduce effect due to load from the urging member.

### Embodiment 4

### [Configuration and Operation of a Moving Mechanism]

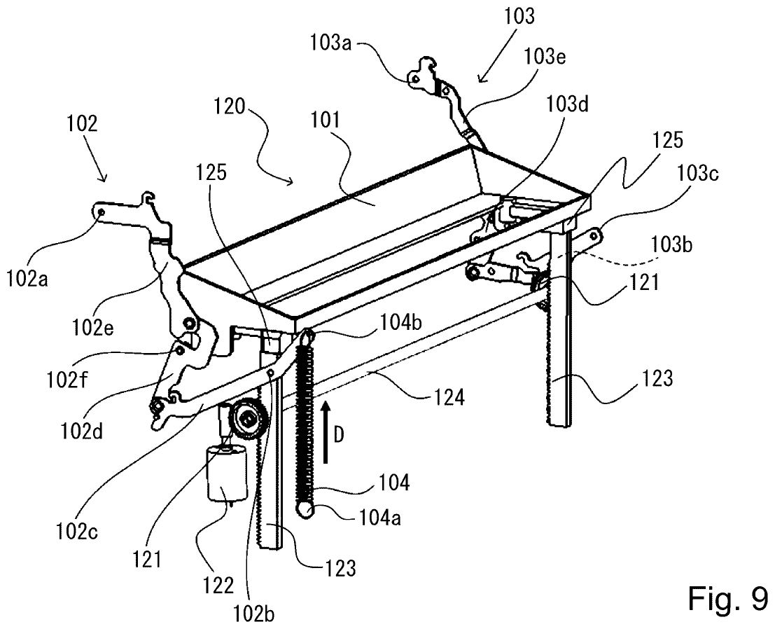

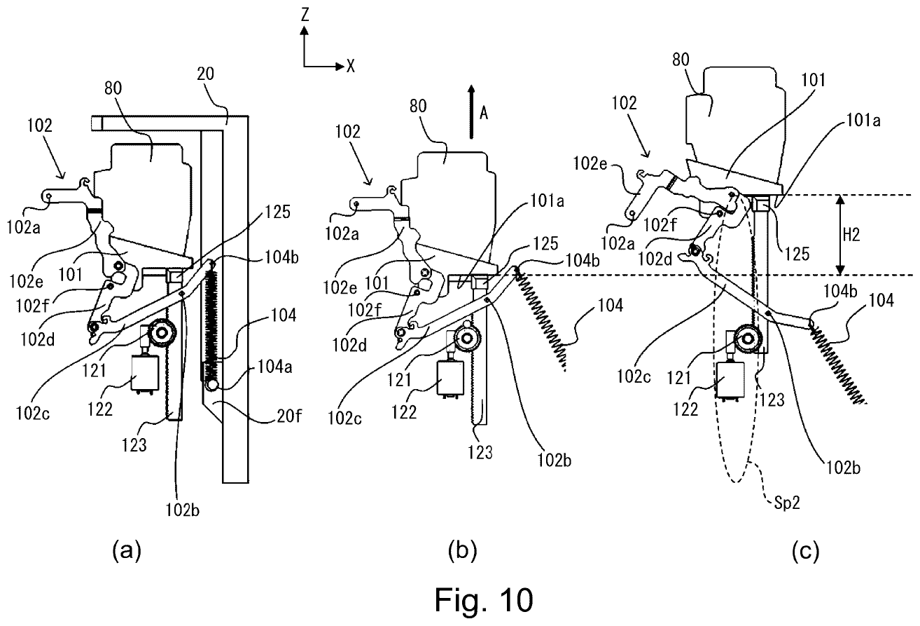

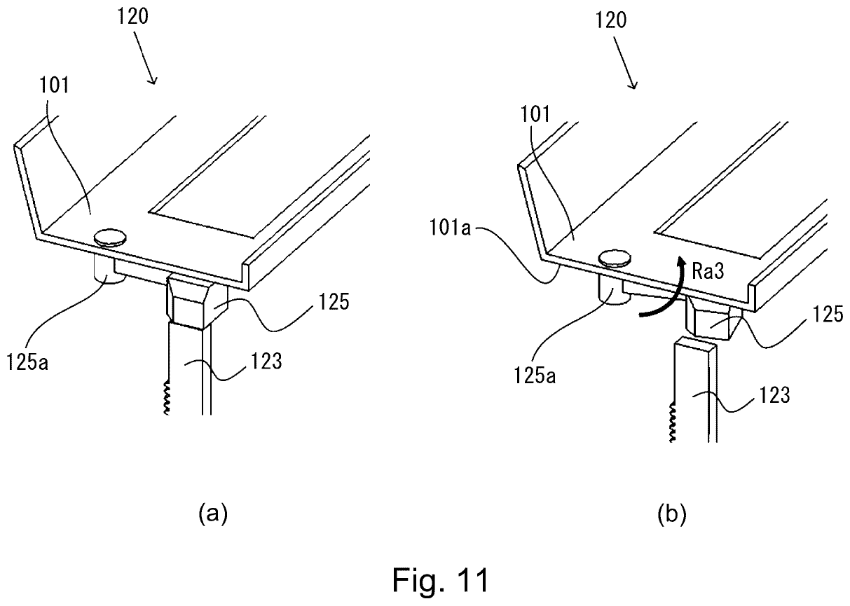

An Embodiment 4 will be described using FIG. 9, part (a) of FIG. 10 through part (c) of FIG. 10, part (a) of FIG. 11 and part (b) of FIG. 11. To portions having the same configuration as in the Embodiment 1, the same reference numerals will be attached, and description thereof will be omitted. FIG. 9 is a perspective view of a moving mechanism 120. The moving mechanism 120 includes a mounting base 101, a gear 121, a rack 123, a shaft 124 connecting the gear 121, and a latch 125. The latch 125 is held by the mounting base 101, and the rack 123 is connected to a motor 122 via the gear 121. The motor 122 is a driving portion which drives, via the rack 123 and the latch 125 as holding members in a holding state, so as to move a fixing device 80 as a moving unit from a first position to a second position. The rack 123 is capable of moving, by the drive of the motor 122, in a direction D shown in FIG. 9. When the rack 123 is moved in the D direction, via the latch 125, the rack 123 causes the moving mechanism 120 to be moved in the D direction. The motor 122 is controlled by a control portion 3.

In the Embodiment 4 as well, similarly to the Embodiment 1, upon replacing the cartridge P, by the fixing device 80 being moved above, the tray unit 50 becomes capable of drawing out. In the Embodiment 4, it is electrically controlled so as the fixing device 80 to be moved only when a volume of the cartridge P becomes a predetermined value or less. By this, it is prevented that the cartridge P is replaced at a wrong timing.

### (On the Volume of the Cartridge P and a Moving Instruction for the Fixing Device)

The volume of the cartridge P means a toner amount in the cartridge P. The control portion 3 monitors the toner amount in the cartridge P, and when the toner amount in the cartridge P becomes the predetermined amount set in advance or less, the control portion 3 displays information prompting the replacement of the cartridge P on an operating panel 6. As a method for detecting the toner amount in the cartridge P, a method using an optical sensor, a method using electrostatic capacitance, etc. can be used.

When the toner amount in the cartridge P becomes the predetermined amount or less, as well as the information prompting the replacement of the cartridge P, in order to secure a space for drawing the cartridge P outside the main assembly 1A, the control portion 3 also displays information prompting a moving instruction for the fixing device 80 on the operating panel 6. In response to the moving instruction for the fixing device 80 being input from the operating panel 6, the control unit 3 starts the driving of the motor 122. In addition, in response to the mounting base 101 being risen to a position (second position) in part (c) of FIG. 10, which will be described below, the control portion 3 stops the driving of the motor 122. Incidentally, the control portion 3 may determine that the mounting base 101 has been risen to the second position in part (c) of FIG. 10, for example, based on a number of rotation, a driving time, etc. of the motor 122, or based on a detection result of a sensor disposed at a height in part (c) of FIG. 10.

### (Configuration of a Link Mechanism)

As shown in FIG. 9 and part (a) of FIG. 10 through part (c) of FIG. 10, to a surface of the door 20 on an inside of the main assembly 1A, a connecting portion 20f, to which one end portion 104a of a spring 104 is connected, is provided, and the one end portion 104a of the spring 104 is connected to the connecting portion 20f. The spring 104 functions as an urging member, which expands and contracts in response to an opening/closing operation of the door 20 and urges the moving unit. In addition, the spring 104 urges the fixing device 80 as the moving unit from the first position toward the second position. The second position is positioned upper than the first position in the Z direction (vertical direction). The spring 104 is in interrelation with the opening/closing operation of the door 20 so that urging force when the door 20 is in the open state becomes larger than the urging force when the door 20 is in the closed state. A link mechanism 102 includes an arm 102c, an arm 102d and an arm 102e. Since the configuration of the arms 102c, 102d and 102e are the same as in the Embodiment 1, description thereof will be omitted.

As shown in FIG. 9, a link mechanism 103 includes an arm 103c, an arm 103d and an arm 103e. In the arm 103c, the other end portion 104b of the spring 104 is connected to one end portion thereof, and one end portion of the arm 103d is connected to the other end portion thereof. At a connecting portion between the arm 103c and the arm 103d, the arm 103c and the arm 103d are capable of rotating relative to each other. The arm 103c is attached to a frame 1C (see FIG. 3) of the main assembly 1A rotatably about a rotational center 103b, and is capable of rotating about the rotational center 103b.

Of the arm 103d, the one end portion is connected to the arm 103c, and the other end portion is connected to one end portion of the arm 103e. The arm 103d is connected to the mounting base 101 at a connecting portion 103f (not shown, opposite side of the connecting portion 102f), and is capable of rotating about the connecting portion 103f. Of the arm 103e, the one end portion is connected to the arm 103d. The arm 103e is attached to a frame 1B (see FIG. 3) of the main assembly 1A rotatably about a rotational center 103a, and is capable of rotating about the rotational center 103a.

In this manner, the link mechanism 102 is attached to the main assembly 1A at the rotational centers 102a and 102b, and the connecting portion 102f of the arm 102d is attached to the mounting base 101. On the link mechanism 102 side, one end portion 104a of the spring 104 is fixed to the door 20. In addition, the link mechanism 103 is attached to the main assembly 1A at the rotational centers 103a and 103b, and the connecting portion 103f of the arm 103d is attached to the mounting base 101. On the link mechanism 103 side as well, one end portion 104a of the spring 104 is fixed to the door 20.

In a state in which the door 20 is closed shown in part (a) of FIG. 10, the spring 104 is slightly expanded from a natural length thereof, and elastic force generated in the spring 104 is extremely small. As shown in part (b) of FIG. 10, upon opening the door 20, the spring 104 is expanded and the elastic force of the spring 104 is increased. As the elastic force of the spring 104 is increased, the spring 104 urges the fixing device 80 and the moving mechanism 120 in an A direction shown in part (b) of FIG. 10. The elastic force of the spring 104 is set weaker than force which causes the fixing device 80 to be moved.

In the state of part (b) of FIG. 10, the control unit 3 displays the information prompting the moving instruction for the fixing device 80 on the operating panel 6. In addition, when the moving instruction for the fixing device 80 is input from the operating panel 6, the control portion 3 starts the driving of the motor 122. The moving mechanism 120 and the fixing device 80 are moved in the A direction shown in part (b) of FIG. 10 by the driving force of the motor 122, and become a state shown in part (c) of FIG. 10. Since the moving mechanism 120 is urged in the A direction by the elastic force of the spring 104, it becomes possible for the motor 122 to cause the moving mechanism 120 to be moved with a smaller torque. As a result, a lower surface 101a of the mounting base 101 is risen above by a height H2 from the state of part (b) of FIG. 10, and a space Sp2 is generated below the fixing device 80.

### [Configuration of the Rack and the Latch]

In part (a) of FIG. 11 and part (b) of FIG. 11, detailed views of the rack 123 and latch 125 are shown. The latch 125 is rotatably supported by the mounting base 101, and is capable of moving from a home position of part (a) of FIG. 11 to a releasing position of part (b) of FIG. 11. The latch 125 corresponds to a first engaging portion provided on the fixing device 80 side (moving unit side). The rack 123 corresponds to a second engaging portion provided on the main assembly 1A side (main assembly side). By the latch 125 and the rack 123 being engaged with each other, it becomes a holding state, in which the fixing device 80 is held, and by the engagement between the latch 125 and the rack 123 being released, it becomes a releasing state, which releases the state of the fixing device 80 being held.

Specifically, the latch 125 is capable of rotating about a rotation shaft 125a, which is rotatably attached to the mounting base 101. The home position of part (a) of FIG. 11 is the state in which the latch 125 and the rack 123 are engaged with each other, and is a state in which when the motor 122 starts the driving thereof and the rack 123 is risen, the mounting base 101 can also be risen. In addition, when the door 20 has become the open state, in order to keep the fixing device 80 in the second position upon moving the tray unit 50, while the door 20 is maintained in the open state, the rack 123 and the latch 125 maintain the engaged state.

On the other hand, a releasing position of part (b) of FIG. 11 is a state in which the latch 125 is rotated in an arrow Ra3 direction and retracted to a lower surface 101a side of the mounting base 101, and is not engaged with the rack 123. In this state, even if the rack 123 is risen or lowered by the drive of the motor 122, the mounting base 101 cannot perform the vertical movement in interrelation with the drive of the motor 122.

### [Opening/Closing Operation of the Door, Vertical Movement of the Fixing Device, Engagement and Release Between the Latch and the Rack]

In the state in which the door 20 is closed as shown in part (a) of FIG. 10, the rack 123 and the latch 125 are engaged with each other, and are in the home position of part (a) of FIG. 11. As a result, when the door 20 is opened, the fixing device 80 is in the state capable of being risen with the start of the driving of the motor 122 (part (b) of FIG. 10). In addition, as shown in part (c) of FIG. 10, even in a state in which the door 20 is opened and the fixing device 80 is stopped at the second position, the rack 123 and the latch 125 are still engaged with each other and are in the home position of part (a) of FIG. 11.

As the door 20 gets to be closed from the state of part (c) of FIG. 10, by the latch 125 being moved to the releasing position in interrelation with the closing operation of the door 20, the engagement with the rack 123 is released (part (b) of FIG. 11). It is configured that the rotation operation of the latch 125 and shifting from the open state to the closed state of the door 20 are interrelated by an unshown link mechanism. By the latch 125 being rotated continuously in interrelation with the shift from the open state to the closed state of the door 20, the engaged state between the rack 123 and the latch 125 is released.

In the Embodiment 4, the urging force of the spring 104 is set weaker than force which supports an own weight of the fixing device 80. Therefore, when the engagement between the rack 123 and the latch 125 is released, it becomes no longer possible to hold the fixing device 80 at the second position, so that the fixing device 80 is lowered by the own weight thereof. However, thanks to the urging force of the spring 104, the descent becomes milder compared to a case in which the spring 104 is absent. In addition, the rack 123, which has been released from the engagement with the latch 125, is lowered by the motor 122 to a position corresponding to the first position of the fixing device 80, i.e., a position of part (a) of FIG. 10. At the first position, the rack 123 and the latch 125 are engaged with each other again, and are prepared for the next rise of fixing device 80.

In this manner, the rack 123 and the latch 125 also serve as the holding member which holds the fixing device 80 at the second position. The rack 123 and the latch 125 are switched between an engaged state (holding state) of holding the fixing device 80 as the moving unit and a releasing state of releasing the holding state. The rack 123 and the latch 125 become the holding state when the door 20 is in the closed state, in the open state and in a process shifting to the open state from the closed state, and become the releasing state when the door 20 is in the process shifting to the closed state from the open state. The urging force of the spring 104 is smaller than the gravitational force acting on the fixing device 80, and fixing device 80 is lowered by the own weight thereof when the rack 123 and the latch 125 become the releasing state.

By configuring as described above, it becomes possible to obtain effects as following. That is, in the state in which the door 20 (opening/closing door) is closed, the urging force of the spring 104 (urging member), which causes the moving mechanism 100 and the fixing device 80 (moving unit) to be moved, does not act on the moving mechanism 100, the fixing device 80, etc., it becomes possible to reduce the force lord applied to the peripheral components. In addition, since the movement of the moving mechanism 120 can be electrically controlled, usability is improved.

As described above, according to the Embodiment 4, in the configuration provided with the moving unit, which is movably provided to the image forming apparatus, it becomes possible to provide an assisting mechanism for the moving unit which can reduce effect due to load from the urging member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-008417, filed Jan. 21, 2025, which is hereby incorporated by reference herein in its entirety.

What is claimed is:

1. An image forming apparatus comprising:
a main assembly;
an openable/closable door between a closed state in which an inside of the main assembly is closed and an open state in which the inside is exposed;
a moving unit provided in the inside of the main assembly and capable of moving to an outside of the main assembly, the moving unit being capable of moving from a first position where the moving unit is mounted on the inside of the main assembly to a second position outside the main assembly and different from the first position when the door is in the open state; and
an urging member configured to urge the moving unit so as to move the moving unit from the first position to the second position,
wherein the urging member expands and contracts in interrelation with an opening/closing operation of the door so that an urging force when the door is in the open state becomes larger than the urging force when the door is in the closed state.

2. The image forming apparatus according to claim 1, further comprising a restricting member configured to be switched between a holding state of holding the moving unit in the first position and a releasing state of allowing the moving unit to move from the first position,
wherein the moving unit is moved toward the second position by the urging force of the urging member when the restricting member becomes the releasing state in the open state of the door.

3. The image forming apparatus according to claim 1, wherein as the door is viewed from a front thereof, the door is capable of rotating about a lower side of the door in a vertical direction as a rotation shaft and becomes the closed state or the open state by a rotating operation thereof.

4. The image forming apparatus according to claim 3, further comprising a link mechanism configured to connect the urging member and the door.

5. The image forming apparatus according to claim 1, wherein the moving unit includes a fixing device configured to fix a toner image formed on a sheet.

6. The image forming apparatus according to claim 1, wherein the moving unit includes a tray on which a toner cartridge, in which toner is accommodated, is mounted.

7. The image forming apparatus according to claim 6, wherein the door includes a first connecting portion to which one end portion of the urging member is connected,
wherein the tray includes a second connecting portion to which the other end portion of the urging member is connected, and
wherein the second connecting portion is positioned closer to the main assembly than the first connecting portion in a direction toward the second position from the first position when the tray is in the second position.

8. The image forming apparatus according to claim 1, wherein the second position is positioned above the first position in a vertical direction,
wherein the urging force of the urging member is larger than a gravitational force acting on the moving unit, and
wherein the moving unit is held in the second position by the urging force of the urging member.

9. The image forming apparatus according to claim 1, wherein the second position is positioned above the first position in a vertical direction,
wherein a holding member configured to switch between a holding state of holding the moving unit in the second position and a releasing state of releasing the holding state is provided, and
wherein the holding member becomes the holding state when the door is in the closed state, in the open state and in a process shifting to the open state from the closed state, and becomes the releasing state when the door is in a process shifting to the closed state from the open state.

10. The image forming apparatus according to claim 9, wherein the holding member includes a first engaging portion provided on a side of the moving unit and a second engaging portion provided on a side of the main assembly, and
wherein the holding member becomes the holding state by engaging the first engaging portion and the second engaging portion, and becomes the releasing state by releasing engagement of the first engaging portion and the second engaging portion.

11. The image forming apparatus according to claim 9, wherein the urging force of the urging member is smaller than a gravitational force acting on the moving unit, and
wherein the moving unit is lowered by own weight when the holding member becomes the releasing state.

12. The image forming apparatus according to claim 9, further comprising a driving portion configured to drive to move the moving unit from the first position to the second position via the holding member which is in the holding state.
